(19) United States
(12) Patent Application Publication
(10) Pub. No.: US 2015/0019294 A1
(43) Pub. Date: Jan. 15, 2015

(54) Projecting Lower-Geographic-Resolution Data onto Higher-Geographic-Resolution Areas

(71) Applicant: PlacelQ, Inc., New York, NY (US)

(72) Inventors: Stephen Milton, Lyons, CO (US); Duncan McCall, Greenwich, CT (US)

(21) Appl. No.: 13/938,974

(22) Filed: Jul. 10, 2013

(51) Int. Cl. G06Q 30/02

(52) U.S. Cl. CPC G06Q 30/0205
USPC 705/7.34

(57) ABSTRACT

Provided is a process of augmenting a geographic information system by projecting lower-geographic-resolution data on to higher-geographic-resolution areas, the process including: obtaining aggregate values each describing an attribute of different coarser geographic areas; obtaining a geographic-information system (GIS) having records each describing attributes of a finer-grained geographic area; identifying, for each of the coarser geographic areas, corresponding finer-grained geographic areas of the GIS; projecting, for each of the coarser geographic areas, the aggregate value of the respective coarser geographic area unevenly onto the corresponding finer-grained geographic areas based on respective attribute values of the corresponding finer-grained geographic areas; and storing in memory of the GIS.

### BACKGROUND

1. Field

The present disclosure relates generally to geographic information systems and, more specifically, to projecting geographic data to higher-spatial resolutions based on higher spatial resolution correlates.

2. Description of the Related Art

An enormous amount of effort is expended to present the right advertisement to the right person at the right time. Consumers have limited attention, and advertisers have limited budgets. And wasting either is expensive. Yet much advertising is still wasted on ads presented to users for whom the advertisement is ineffective or not relevant.

Accordingly, advertisers are interested in techniques for targeting their advertising efforts. A particularly powerful criteria for targeting advertisements is geographic location. Often advertisers find location to convey useful information about the type of consumers that will be potentially exposed to an advertisement, and the location history of consumers is often indicative of which ads are likely to be relevant to those consumers. Consequently, advertisements are often purchased for presentation in a geographic area or targeted to specific consumers based, in part, on their location history.

Obtaining relatively detailed and accurate information about people and places is difficult, particularly at a scale and specificity of interest to advertisers. Many advertising campaigns target entire cities, regions, or countries, encompassing large areas, and a large number of people. At the same time, advertisers generally want relatively detailed information about geographic areas and people to precisely target advertisements within those campaigns. In particular, many advertisers and other users of geographic information systems seek relatively high-spatial resolution data about geographic areas and, specifically, the activities of consumers and others in those areas. Such high-resolution data is used to gain relatively detailed insights into which areas are likely to be populated with targeted segments of the population.

Gathering such high-resolution information exclusively by manually surveying geographic areas and people is generally prohibitively expensive and slow. And to the extent electronic records about geographic areas and people are available, those records often describe geographic areas at lower-levels of specificity than is sought by advertisers or others making decisions based on attributes of geographic areas.

### SUMMARY

The following is a non-exhaustive listing of some aspects of the present techniques. These and other aspects are described in the following disclosure.

Some aspects include a process of augmenting a geographic information system by projecting lower-geographic-resolution data on to higher-geographic-resolution areas, the process including: obtaining aggregate values each describing an attribute of different coarser geographic areas; obtaining a geographic-information system (GIS) having records each describing attributes of a finer-grained geographic area, wherein a plurality of the finer-grained geographic areas are in each of the coarser geographic areas; identifying, for each of the coarser geographic areas, corresponding finer-grained geographic areas of the GIS that are in the respective coarser geographic area; projecting, for each of the coarser geographic areas, the aggregate value of the respective coarser geographic area unevenly onto the corresponding finer-grained geographic areas based on respective attribute values of the corresponding finer-grained geographic areas; and storing in memory of the GIS, for each of the corresponding finer-grained geographic areas of each of the coarser geographic areas, the respective projected value in association with the respective finer-grained geographic area, wherein the respective projected values have different values in the different corresponding finer-grained geographic areas of a given coarser geographic area.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of a computing environment having a geographic-data projector in accordance with some embodiments;

FIG. 2 shows an example of a process for projecting coarser grained geographic data onto finer grained areas in accordance with some embodiments; and

FIG. 3 shows an example of a computing system by which the above-mentioned processes and systems may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

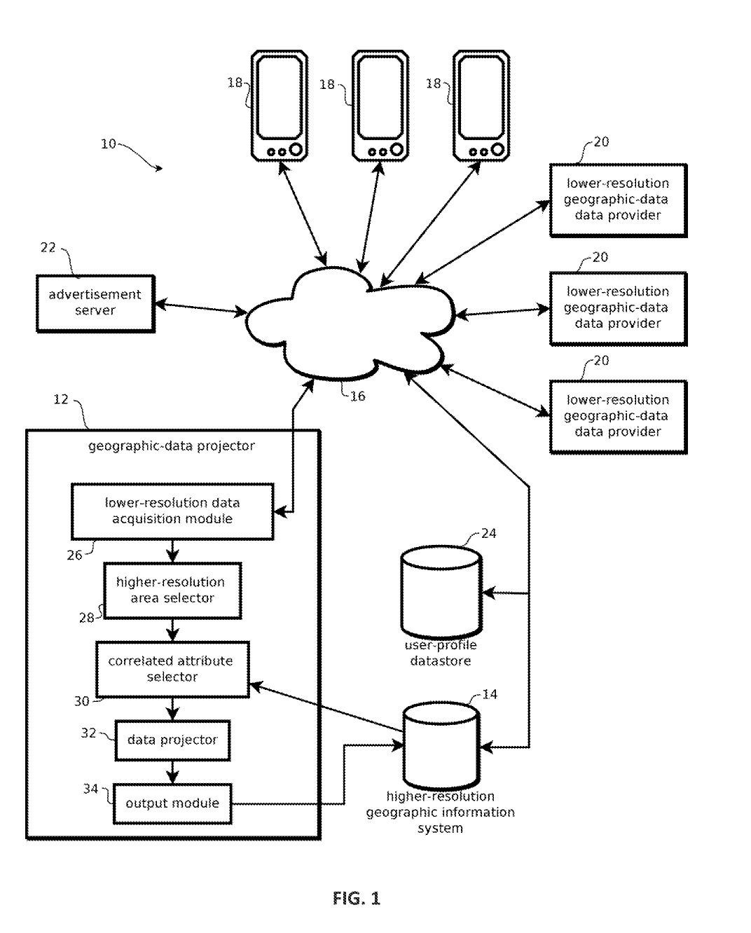

FIG. 1 shows a computing environment 10 having a geographic-data projector 12 operative to mitigate, in some embodiments, some of the above-mentioned challenges with obtaining relatively detailed and relatively comprehensive information about people and places over relatively large areas and populations. Embodiments acquire lower-spatial-resolution data, for example, statistics aggregated over by zip code, and project this data onto smaller, higher-spatial-resolution areas, for instance, 100-meter by 100-meter tiles within each zip code. In some embodiments, the projection is uneven among the smaller areas, accounting for the estimated contribution of each smaller area to the aggregate value of the larger area.

Such lower-resolution data is, for a variety of reasons, often more readily available than data about individuals or smaller areas. Many government and commercial entities collect and publish data aggregated at lower spatial resolutions because of privacy concerns of individuals, a proprietary interest in more specific data, and the cost and complexity associated with larger, more specific data sets. For advertisers, however, attributes aggregated at, for example, the county or state level, may be insufficiently specific to target advertisements with a desired degree of specificity. For instance, lower-resolution data may indicate that the average income in a zip code is near some value, but one third of the population in a zip code may account for this value much more strongly than the other two thirds. And an advertiser may prefer to concentrate their advertising efforts on that one third of the population likely having a higher income, but discerning this from the aggregate value is difficult. This problem is addressed by some embodiments of the geographic-data projector 12. A relatively specific example is helpful for understanding its operation, but the reader should note that embodiments are consistent with a wide variety of different applications.

In one example, the geographic projector 12 may acquire United States Census data describing for each United States zip code the total number of residents of the respective zip code. Residential addresses, however, are often not uniformly distributed. For example, one third of a zip code may be a park or an industrial area in which no one lives. Simply looking at the total number of residents for the zip code would lead an advertiser to assume a relatively low density of residents when the residents are in fact concentrated in a smaller subset of the zip code. The geographic-data projector, in some cases, subdivides (e.g., quantizes) the zip code according to higher-resolution geographic areas (e.g., one-hundred meter by hundred-meter squares) characterized in a higher-resolution geographic information system 14. For each of these higher-resolution geographic areas, the geographic-data projector 12, in some cases, then retrieves a value correlated with the presence of residential addresses, such as a residential-address score for each high-resolution area, or value indicative of the density of cable subscriptions. The value for the entire zip code, then, is projected unevenly onto the higher resolution geographic areas based on the correlated value of each high-resolution area, attributing a greater portion of the zip code level population to those high-resolution areas that have a higher correlated value, and vice versa. Thus, in this example, the portion of the zip code corresponding to a park or an industrial area would have a relatively low correlated value and would receive, in the portion of the output describing those areas, a relatively low portion of the population documented at the zip code level.

This example, however, is purely illustrative, and embodiments are consistent with other types of lower-resolution geographic data, other correlated values, and other purposes, examples of which are described in greater detail below after introducing other aspects of the computing environment 10.

As shown in FIG. 1, the computing environment 10 further includes the higher-resolution geographic information system 14, the Internet 16, user devices 18, lower-resolution geographic data providers 20, an advertisement server 22, and a user-profile data store 24. The components of the computing environment 10 may connect to one another through the Internet 16 and, in some cases, via various other networks, such as cellular networks, local area networks, wireless area networks, personal area networks, and the like.

The geographic information system 14 may be configured to provide information about geographic locations in response to queries specifying a location of interest. In some embodiments, the geographic information system 14 organizes information about a geographic area by quantizing (or otherwise dividing) the geographic area into area units, called tiles, that are mapped to subsets of the geographic area. In some cases, the tiles correspond to square units of area having sides that are between 10-meters and 1000-meters, for example, approximately 100-meters per side, depending upon the desired granularity with which a geographic area is to be described. Tiles are, however, not limited to square-shaped tiles, and may include other tilings, such as a hexagonal tiling, a triangular tiling, or other regular tilings (for simpler processing), semi-regular tilings, or irregular tilings (for describing higher density areas with higher resolution tiles, while conserving memory with larger tiles representing less dense areas).

In some cases, the attributes of a geographic area change over time. Accordingly, some embodiments divide each tile according to time. For instance, some embodiments divide each tile into subsets of some duration of time, such as one week, one month, or one year, and attributes of the tile are recorded for subsets of that period of time. For example, the period of time may be one week, and each tile may be divided by portions of the week selected in view of the way users generally organize their week, accounting, for instance, for differences between work days and weekends, work hours, after work hours, mealtimes, typical sleep hours, and the like. Examples of such time divisions may include a duration for a tile corresponding to Monday morning from 6 AM to 8 AM, during which users often eat breakfast and commute to work, 8 AM till 11 AM, during which users often are at work, 11 AM till 1 PM, during which users are often eating lunch, 1 PM till 5 PM, during which users are often engaged in work, 5 PM till 6 PM, during which users are often commuting home, and the like. Similar durations may be selected for weekend days, for example 8 PM till midnight on Saturdays, during which users are often engaged in leisure activities. Each of these durations may be profiled at each tile.

In some embodiments, the geographic information system 14 includes a plurality of tile records, each tile record corresponding to a different subset of a geographic area. Each tile record may include an identifier, an indication of geographic area corresponding to the tile (which for regularly sized tiles may be the identifier from which location can be calculated or may be a polygon with latitude and longitude vertices, for instance), and a plurality of tile-time records. Each tile-time record may correspond to one of the above-mentioned divisions of time for a given tile, and the tile-time records may characterize attributes of the tile at different points of time, such as during different times of the week. Each tile-time record may also include a density score indicative of the number of people in the tile at a given time. In some embodiments, each tile-time record includes an indication of the duration of time described by the record (e.g. lunch time on Sundays, or dinnertime on Wednesdays) and a plurality of attribute records, each attribute record describing an attribute of the tile at the corresponding window of time during some cycle (e.g., weekly).

The attributes may be descriptions of activities in which users engage that are potentially of interest to advertisers or others interested in geographic data about human activities and attributes (e.g., geodemographic data or geopsychographic data). For example, some advertisers may be interested in when and where users go to particular types of restaurants, when and where users play golf, when and where users watch sports, when and where users fish, or when and where users work in particular categories of jobs. In some embodiments, each tile-time record may include a relatively large number of attribute records, for example more than 10, more than 100, more than 1000, or approximately 4000 attribute records, depending upon the desired specificity with which the tiles are to be described. Each attribute record may include an indicator of the attribute being characterized and an attribute score indicating the degree to which users tend to engage in activities corresponding to the attribute in the corresponding tile at the corresponding duration of time. In some cases, the attribute score (or tile-time record) is characterized by a density score indicating the number of users expected to engage in the corresponding activity in the tile at the time.

Thus, to use some embodiments of the geographic information system 14, a query may be submitted to determine what sort of activities users engage in at a particular block in downtown New York during Friday evenings, and the geographic information system 14 may respond with the attribute records corresponding to that block at that time. Those attribute records may indicate a relatively high attribute score for high-end dining, indicating that users typically go to restaurants in this category at that time in this place, and a relatively low attribute score for playing golf, for example. Attribute scores may be normalized, for example a value from 0 to 10, with a value indicating the propensity of users to exhibit behavior described by that attribute.

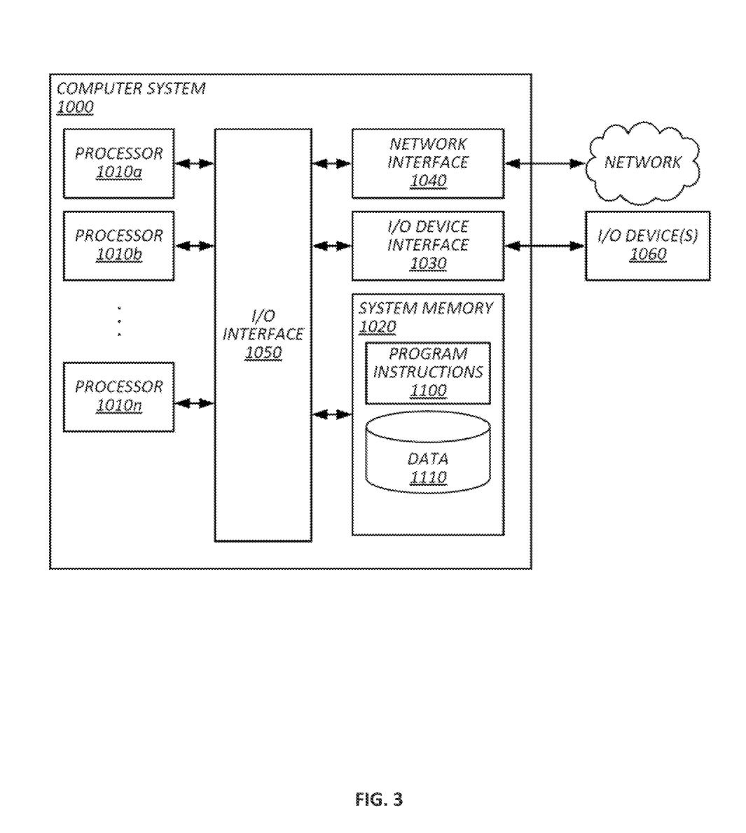

In FIG. 1, three user devices 18 are illustrated, but it should be understood that embodiments are consistent with substantially more user devices. The illustrated user devices 18 may be mobile handheld user devices, such as smart phones, tablets, or the like, having a portable power supply (e.g., a battery) and a wireless connection, for example, a cellular or a wireless area network interface. Examples of computing devices that, in some cases, are mobile devices are described below with reference to FIG. 3. User devices 18, however, are not limited to handheld mobile devices, and may include desktop computers, laptops, vehicle in-dash computing systems, living room set-top boxes, and public kiosks having computer interfaces. In some cases, the user devices 18 number in the millions or hundreds of millions and are geographically distributed, for example, over an entire country or the planet.

Each user devices 18 may include a processor and memory storing an operating system and various special-purpose applications, such as a browser by which webpages and advertisements are presented, or special-purpose native applications, such as weather applications, games, social-networking applications, shopping applications, and the like. In some cases, the user devices 18 include a location sensor, such as a global positioning system (GPS) sensor (or GLONASS, Galileo, or Compass sensor) or other components by which geographic location is obtained, for instance, based on the current wireless environment of the mobile device, like SSIDs of nearby wireless base stations, or identifiers of cellular towers in range. In some cases, the geographic locations sensed by the user devices 18 may be reported to the advertisement server 22 for selecting advertisements to be shown on the mobile devices 18, and in some cases, location histories (e.g., a sequence of timestamps and geographic location coordinates) are provided for updating and augmenting the user-profile data store 24 and the geographic information system 14. For instance, the number of people in a particular geographic area at a particular time as indicated by such location histories may be used to update records in the higher-resolution geographic information system 14, and the attributes of geographic areas through which individual users travel, as also indicated by the location histories, may be used to populate and update profiles on those individual users in the user profile data store 24. Location histories may be acquired by batch, e.g., from application program interfaces (APIs) of third-party providers, like cellular-network operators, advertising networks, or providers of mobile applications. Batch formatted location histories are often more readily available than real-time locations, while still being adequate for characterizing longer term trends in geographic data. And some embodiments may acquire locations in real time, for instance, for selecting a particular advertisement to be displayed based on the current location.

FIG. 1 shows three lower-resolution geographic data providers 20, but again, embodiments are consistent with substantially more instances, for example, numbering in the hundreds of thousands. The lower-resolution geographic data providers 20 are shown as network connected devices, for example, servers hosting APIs by which geographic data is requested by the geographic-data projector 12, or in webpages from which such data is retrieved or otherwise extracted. It should be noted, however, that in some cases the lower-resolution geographic data may be provided by other modes of transport. For instance, hard-disk drives, optical media, flash drives, or other memory may be shipped by physical mail and copied to a local area network or on-board memory accessible to the geographic-data projector 12. Generally, the lower-resolution geographic data is acquired in batches, for example periodically, such as daily, weekly, monthly, or yearly, but embodiments are consistent with continuous data feeds as well.

As referenced herein, lower-resolution geographic data is lower-resolution relative to the geographic resolution of higher-resolution geographic data. A similar convention is used for finer-grained versus coarser-grained areas or larger versus smaller areas. For instance, the size of the area over which geographic attributes are aggregated is larger in the lower-resolution geographic data than the size of the area over which geographic attributes are aggregated in the geographic information system 14. Thus, a single unit of area in the lower-resolution geographic data may contain multiple corresponding units of area in the geographic information system 14, for example, more than two, more than 32, or more than several thousand, depending upon the relative areas and tradeoffs between memory, speed, and specificity.

Generally, the entity operating the geographic-data projector 12 does not have control over the resolution of the lower-resolution geographic data, as that data is often provided by a third-party, in some cases, for free from the government. In some cases, the lower-resolution geographic data comprehensively canvasses a larger geographic area, for example, every zip code, county, province, or state within a country, or the lower-resolution geographic data may be specific to a particular area, for example, within a single province or state for data gathered by local government or local businesses.

The lower-resolution geographic data may define one or more lower-resolution geographic areas, each such area corresponding to a record identifying the geographic area, and including one or more aggregate attributes (e.g. statistics) that are aggregated over the respective area, such as population, income, percentage of the population having some attribute (e.g., owning a car, liking a particular brand, engaging in a particular profession, or the like). Examples of lower-resolution geographic data include the United States Census data, purchasing data from credit-card companies (e.g., data documenting statistics on purchasing behavior over an area), data on automotive ownership compiled by third parties, data from payroll providers, and the like.

The illustrated advertisement server 22 is operative to receive a request for advertising content, select content (e.g. images and text), and send the advertisement for display or other presentation to a user. One advertisement server 22 is shown, but embodiments are consistent with substantially more, for example, numbering in the thousands. In some cases, advertisements are selected based on the geographic location of a computing device upon which an advertisement will be shown, which may be indicated by an IP address geocoded to a geographic location or location sensed by the displaying device. In other examples, advertisements are selected based on user profiles, which in some cases, are formed based on geographic locations through which users travel and the attributes of those geographic locations. To select advertisements, the advertisement server 22 may request attributes of a user from the user profile data store 24, the user being identified in the request for an advertisement to the advertisement server 22, or the advertisement server 22 may request from the geographic information system 14 attributes of a geographic area into which an advertisement will be served. In some cases, the advertisement is selected based on the responsive data. For example, advertisers may specify a certain bid amount based on the attributes of the geographic area of the user profile, or the advertiser may apply various thresholds, requiring certain attributes before an advertisement served, to target advertisements appropriately.

In some cases, advertisements are selected manually, for example advertisements on billboards or in print media, such as mass mailings, based on information in the geographic information system 14 and the user-profile data store 24. In such cases, users operating one or more of the user devices 18 may query the user profile data store 24 or the geographic information system 14, for example, upon specifying login credentials indicating a paid subscription), and the user may retrieve various reports indicating users having desirable attributes or geographic areas having desirable attributes for targeting advertisements.

It should also be noted, however, that applications are not limited to the selection of advertisements. Various other entities may use geographic data for other purposes, for example, local government for determining how to provide various government services, such as routing of roads, dispatch of police, or positioning of schools. Similarly, businesses may use the user profiles and geographic data for site selection of various types of businesses, such as restaurants, automotive shops, retail stores, and the like, to position such services and facilities near people having the appropriate attributes.

The user profile datastore 24 may be operative to store user profiles and, in some embodiments, address queries for data in the user profiles. User profiles may be formed by assigning to users the attributes of the geographic areas in the geographic information system through which the user passes, as indicated by location histories of respective users. The illustrated user-profile datastore 24 includes a plurality of user-profile records, each record corresponding to the profile of a given user or a given mobile device 18. Each user-profile record may include an identifier of the record (which may be a value otherwise uncorrelated with the identity of the user to enhance privacy), and an identifier of the source or sources of the location histories from which the profile was created such that subsequent location histories can be matched with the profile (e.g. a account associated with a special-purpose application, a cell phone number, or some other value, which may be hashed to enhance user privacy).

Each user-profile record may also include a plurality of profile time records indicating attributes of the user profile at different times during some cycle of time (e.g., portions of the week or month, or during other periods like those described above with reference to the geographic information system 14). In some cases, the profile-time records may correspond to the same durations of time as those of the tile-time records described above. Each profile-time record may include an indication of the duration of time being described (e.g. Thursday's at dinnertime, or Saturday midmorning) and a plurality of profile attribute records, each profile attribute record indicating the propensity of the corresponding user to engage in an activity described by the attribute during the corresponding time of the profile-time record. The profile time records may allow tracking of when users tend to engage in a given activity (time of day, day of week, week of year). In some embodiments, the profile attribute records correspond to the same set of attribute records described above with reference to the geographic information system 14. Each profile-attribute record may include an indication of the attribute being characterized (e.g., attending a children's soccer game, having brunch at a fast-casual dining establishment, parent running errands, or shopping at a mall) and a score indicating the propensity of the user to engage in the activity at the corresponding time, such as a normalized value from 0 to 10. The attribute records may further include a sample size, indicative of the number of samples upon which the attribute score is based, for weighting new samples, and a measure of variance among these samples (e.g., a standard deviation) for identifying outliers.

As described below, the user-profile records may be used for a variety of purposes. For example, advertisers operating ad servers 22 may submit to the user-profile datastore 24 a query identifying one of the user-profile records, such as the above-mentioned hashed value of a user account number or phone number, and the user-profile datastore 24 may respond with the attributes of the corresponding user at the current time. In some embodiments, to further enhance user privacy, queries may be submitted for a specific attribute to determine whether to serve an advertisement corresponding to the attribute, or a query may request a binary indication of whether the attribute score is above a threshold.

In this embodiment, the geographic-data projector 12 includes a lower-resolution data acquisition module 26, a higher-resolution area selector 28, a correlated attribute selector 30, a data projector 32, and an output module 34. In some applications, these components 26, 28, 30, 32, and 34 communicate with one another to take lower-geographic resolution data that characterizes relatively large areas with aggregate statistics and project those values onto higher-geographic resolution areas (e.g., smaller and more-finely quantized geographic areas) based on attributes of the higher-resolution geographic area that correlate with the contribution of those areas toward the aggregate value for the larger, lower-resolution geographic area. That is, in some cases, a value characterizing a geographic area is mapped to smaller constituent areas according to the likely contribution of those constituent areas to the value, where the likely contribution is inferred from correlate values of the constituent areas. Examples of the correlate values include the population in the constituent areas at various times, and the portions of the population in the constituent areas having various attributes that correlate with contribution to the aggregate value.

The lower-resolution data acquisition module 26, in some embodiments, is operative to obtain the lower-resolution geographic data from, for example, one of the above-mentioned sources 20. The acquired data, in some cases, is acquired as a batch of data describing a relatively large area, such as a census report or Nielsen's™ report of media consumption for an entire country. In some cases, an administrator instructs the geographic-data projector 12 to ingest such a batch of data by identifying the location of the data, e.g., in an identified file in a directory or at a URL accessed over the Internet 16, and providing a command to acquire the data. In some cases, the lower-resolution data acquisition module 26 is operative to partition the acquired data by lower-resolution geographic area, creating input-records, each input record having an identifier of the geographic area and one or more aggregate values attributed to the respective area.

In some embodiments, the geographic area is identified by translating between corresponding geographic identifiers, translating, for instance, from state, zip code, county, province, city, or the like, to a designation more readily correlated with tiles in the geographic information system 14. For example, embodiments may store in memory a mapping associating these lower-resolution geographic area designations with the corresponding boundaries of the areas, such as polygon having latitude and longitude defined vertices approximating the boundaries of the area. Each input record, in such embodiments, may be associated with the corresponding polygon or other translated format for the geographic area to facilitate identification of corresponding tiles.

Each of the input records may then be advanced to the higher-resolution area selector 28, which in some embodiments is operative to select for each input record higher-resolution geographic areas corresponding to (e.g., within or, in some cases, overlapping) the larger geographic area of the input record. In some cases, the higher-resolution area selector 28 queries the geographic information system 14 with a request for identifiers of tiles corresponding to a polygon (or other designation, such as a zip code or name) of the larger geographic area, and the geographic information system 14 returns a set of responsive tile identifiers. In some embodiments, e.g., where the tiles are relatively small compared to the larger geographic area, a binary determination is made, and tiles are designated as corresponding to the larger geographic areas based on a threshold amount of overlap, e.g., if the tile is more than 50% within the larger area, the identifier of the tile is appended to the set of tiles corresponding to the larger geographic area. Or tiles may each be associated with a single geographic coordinate, e.g., a center point latitude and longitude, and tiles may be designated as part of the larger area based on whether the single geographic coordinate is in the area. For instance, a point may be determined to be within a polygon of arbitrary shape based on a raycasting algorithm by which the number of times a ray passing through the point intersects the polygon is counted, starting with zero on the exterior, and the tile is designated as being in the larger area if and only if the count is an odd number when passing through the point. In some cases, each tile identifier is associated with a value indicating the degree to which the tile is within the larger geographic area, for example, a value of 100% for tiles fully encompassed, a value of 50% for a tile on the edge of the larger geographic area and bisected by the boundary, and so on, assigning lower values to tiles on the edge, depending on the amount of the tile in the larger area. The input records are, in some embodiments, then associated with the responsive set of tiles and, in some cases, corresponding values indicating the degree of overlap.

In some cases, the number of input records is relatively large, and multiple instances of the components of the geographic-data projector 12 may be instantiated to process multiple different input records concurrently. Similarly, multiple batches of lower-resolution geographic data may be processed concurrently by instantiating multiple instances of the geographic-data projector 12. To facilitate concurrent operations, some embodiments of the geographic information system 14 may be operative to lock tiles by setting a flag in memory where, for example, the value being down projected in one operation serves as a correlating value in a concurrent operation, and instances of the geographic-data projector 12 may be operative to detect when a tile is locked and pause until tiles in an area being processed are unlocked. Or where changes to tile records are relatively independent, locking may not be applied, which is not to suggest that any other feature cannot also be omitted in some embodiments.

The correlated attribute selector 30, in some embodiments, is operative to obtain values for each tile (or other higher-resolution geographic area to which lower-resolution values are to be projected) that correlate to the contribution of that tile to the aggregate value of the larger geographic area. The correlate may be (or may be based on) one or more of the above-mentioned attribute values of the respective tiles, such as an attribute value of a tile-time record, a density score of a tile-time record, or a combination thereof. In some cases, the correlate is an estimated population of the tile during a duration of time of a tile-time record, or the correlate may be the based on the density score and an attribute value. For example, when a particular tile-time record attribute is relatively strongly correlated to an aggregate value of the input record, the correlate value may be the product of that tile-time record attribute value and the density score for the tile. Or the density score itself, or a population for the tile, may be used as the correlate value where, for example, population accounts relatively accurately for the contribution of the tile to the aggregate value without accounting for attributes of the population.

In some cases, a plurality of correlate values are obtained for each tile (or other higher-resolution division of geography), for instance, one correlate value for each duration of time of the tile-time records. The contribution of different tiles toward the aggregate value may vary over time as, for instance, people move from home to work to restaurants and bars, and back home in the evening. Tile-time record specific correlates may be used to account for these changes. Thus, where the contribution of a tile toward the aggregate value arises from activities during a particular time of day, a different correlate value for each tile-time record may account for some of this variation. Or some embodiments may calculate an average or single correlate value for all of the tile-time records of each tile.

In some cases, correlate values are calculated with models. For instance, each type of aggregate value of the input records may be associated with a model that estimates the value of the type of aggregate for a tile-time record based on the density score and attribute values of the tile-time record. Each model may include a set of weights associated with each of the attribute values for each of the tile-time durations, e.g., five sets of weights for five tile-time durations. The model may be used to calculate an estimated contribution of the respective tile at the time of the tile-time record toward the aggregate value, e.g., based on the product of the density score and a weighted sum of the attribute values for the tile-time record. Models, in some cases, may also account for (e.g., include in a weighted sum) interactions between attribute values of the tile-time records, determining weights for interaction variables, e.g., two way interactions, three way interactions, or more complex interactions, depending on processing time, memory constraints, and desired accuracy.

Models may be provided by a human operator or built automatically, e.g., based on an analysis of variance of the tile-time record attribute values and a sample of the corresponding type of the aggregate value measured at higher resolution within the sample of tiles, or by aggregating (e.g., averaging, calculating a median, or calculating other characteristic values) tile-time record attribute values over the lower-resolution areas and performing an analysis of variance between the resulting values and the aggregate values. These model parameters (e.g., a set of weight vectors, one for each time duration of the tile-time records, and each scalar of the vectors corresponding to an attribute of the tile-time records) may be stored in memory, for example in the geographic information system 14. And each type of aggregate value may have a weight vector to be projected on the higher-resolution areas, as different types of aggregate values may be modeled differently. Thus, the correlate values may be determined based on a model associated with the type of aggregate value, e.g., based on a weighted combination of tile-time record attribute values, a tile-time record density score, and the weight vector specifying the model for the type of aggregate value to calculate a weighted sum. Or some embodiments may use a single value, such as population, for each type of aggregate value.

Accordingly, in some embodiments, each input record may include multiple types of aggregate values, and each value may implicate a different model for calculating the correlate value for each tile or tile-time record. For each type of aggregate value, the correlated attribute selector 30 may detect the type of aggregate value, retrieve the corresponding weight vector, and calculate correlate values for each tile-time record in the larger areas based on the tile-time record attribute values and weight vector. Thus, in some cases, each tile associated with each input record by the high-resolution area selector 28 may be associated with a plurality of tile-time records, and each tile-time record may have a different correlate value for each of the aggregate values according to the model for the type of aggregate value. Or embodiments are consistent with simpler implementations, e.g., embodiments that do not account for variations in the time of day, or embodiments that use as the correlate value a population of each tile without regard to attributes of the population, which is not to suggest that any other feature may not also be omitted. The resulting input records and associated data (e.g., tiles and correlate values) may then be advanced to the data projector 32.

In some embodiments, the data projector 32 is operative to add or modify attribute values of the tiles, e.g., tile-time record attribute values, based on the input aggregate value of the larger area containing the tile and do so unevenly among the tiles within the larger area based on the correlate values. For instance, total household income for a zip code may be attributed to tiles having correlate values indicative of residences in the corresponding tiles in that zip code. In a zip code that is only one-third residential, all of the total income may be attributed to the residential tiles and none toward non-residential tiles, as indicated by the correlate values of the tiles. In another example, a tile that has a correlate value of 5 may be attributed half as much of the aggregate value as a neighboring tile with a correlate value of 10. Thus, some embodiments project the aggregate value for the larger area down to the smaller, higher-resolution tiles in a more accurate fashion than merely allocating the aggregate value evenly among the tiles, e.g., dividing an aggregate total by the number of tiles, or designating the constituent tiles as having the same average value as the larger area.

In some embodiments, the data projector 32 is operative to normalize the correlate values within the larger area of an input record, e.g., normalizing among sets of correlate values of a given duration of time of tile-time records, normalizing correlate values among durations of time, or normalizing correlate values among tile records without regard to a particular time of day. For example, embodiments may sum a set of correlate values for tiles deemed to be in the larger area of a single input record and divide each correlate value in the set by the sum, such that the total of the correlate values in a normalized set correspond to a total contribution of one, and each normalized correlate value indicates an estimated percentage contribution of that tile toward the aggregate value. In some cases, depending on the type of aggregate value, sets of correlate values for each time duration of the tile-time records are collectively normalized when, for example, the aggregate value is a total that potentially accumulates during each of the durations. Or a single set of normalized correlate values (e.g., a duration-weighted average across the durations) may be shared across the tile-time records. In cases where the aggregate value is of a different type, such as a per-capita value, correlate values may be normalized within each duration of the tile-time records. Some embodiments use a single set of correlate values across each duration of time, and such embodiments may normalize correlate values among the single set.

In some embodiments, the data projector 32 is further operative to project the aggregate value of the larger area of the input record onto the smaller, higher-resolution areas (e.g. tiles) according to the normalized correlate values. For example, each normalized correlate value may be multiplied by the aggregate value, and the product may be associated with the tile of the respective correlate value, for instance, as an attribute of the tile or an attribute of a tile-time record, depending upon whether the use case accounts for variations in the time of day. In some cases, the product is associated with each tile-time record of the respective tile as an attribute value, approximating the appropriate value without regard to the time of day. Or resulting time-of-day specific attribute values may be associated with each tile-time record. In some cases, the product is scaled, for example, between 0 and 10, to use a similar scaling as is applied with the existing tile-time record attribute values.

As a result, in some embodiments, each tile or each tile-time record corresponding to the larger area of an input record is associated with a projected value as an attribute, and that attribute approximately accounts for the contribution of the tile to the aggregate value. Thus, tiles that contribute more (as indicated by their respective correlate values) are affected more than tiles that contribute less, for instance, with a larger or smaller value as an attribute. The aggregate value may be projected for each input record, for each type of aggregate value, for each tile, and for each tile-time record, by multiplying the respective normalized correlate value by the respective aggregate value. Or embodiments may perform less specific projections, for example, projecting the same value to each tile-time record of a given tile.

As noted above, some embodiments may designate tiles on the edge of the larger geographic area of the input record with data indicative of the portion of the edge tiles that are within the larger geographic area, for example, tiles that are 20% within the larger area or tiles that are 80% within the larger area. In some cases, the attribute values for these tiles are calculated by a weighted sum of the attribute values calculated from the adjacent larger geographic areas, with the weighting for each tile being the amount of the tile in the respective larger geographic areas.

The output module 34 of this embodiment may store the resulting updated or new attribute values for each tile or tile-time record in the geographic information system 14. In some cases, the calculated projected attribute values are used to create new attribute values in each tile or tile-time record. In this case, the type of aggregate value may be associated with a name or other identifier of the new attribute value to be created. Or the type of aggregate value may be associated with an existing attribute, and the existing attribute may be updated, for example, replaced or aggregated with the projected values. In some cases, the existing attribute values may be associated with a weighting, for example, the product of a sample size and a freshness score (for instance a value that decays logarithmically with time since the data was updated), and the new projected values may be associated with another weighting (e.g., a user specified weighting), such that the two weighted values may be combined as a weighted sum based on sample size, age of the data, and quality of the data.

The resulting updated or new attribute values of the higher-resolution geographic areas, in some embodiments, account for the lower-resolution data of the larger geographic areas unequally, based on the estimated contribution of each higher-resolution geographic area to the aggregate value of the lower-resolution geographic area in which it is disposed. The resulting attribute values may be used by advertisers or others to make inferences about attributes of relatively small geographic areas using the more-readily available, often less expensive, lower-resolution geographic data.

Embodiments of the computing environment 10 are described above with reference to discrete functional blocks, but it should be understood that embodiments are consistent with various other arrangements, for example, code or hardware by which such functionality is provided may be subdivided, conjoined, intermingled, distributed, co-located, or otherwise differently arranged. The functionality described herein may be provided by a data processing apparatus, an example of which is described below with reference to FIG. 3, executing instructions encoded in a tangible, non-transitory, machine-readable medium, such that when the instructions are executed, the data processing apparatus effectuate the functionality described herein.

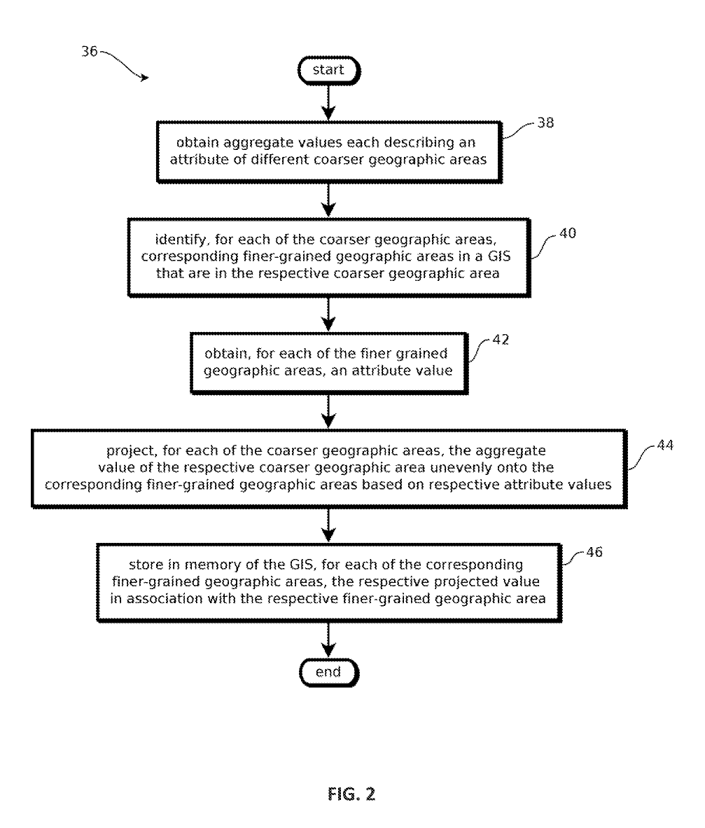

FIG. 2 shows an example of a process 36 for projecting coarser-grained geographic data onto finer-grained geographic areas. The process 36, in some cases, is performed by the above-described geographic-data projector 12, but embodiments are not limited to this particular implementation. The process 36 may be encoded in a tangible, non-transitory, machine-readable medium, and those instructions, when executed by a data processing apparatus, may cause the data processing apparatus to effectuate the presently described operations.

The process 36, in this embodiment, includes obtaining aggregate values each describing an attribute of different coarser geographic areas, as indicated by block 36. Next, for each of the coarser geographic areas, embodiments identify corresponding finer-grained geographic areas in a geographic information system that are in the respective coarser geographic areas, as indicated by block 40. In some embodiments, for each of the finer-grained geographic areas, an attribute value is obtained, as indicated by block 42. In some embodiments, for each of the coarser-grained geographic areas, the aggregate value of the respective coarser-grained geographic area is projected unevenly onto the corresponding finer-grained geographic areas based on respective attribute values, as indicated by block 44. In some cases, projecting unevenly may yield some coarser-grained geographic areas in which all of the finer-grained geographic areas receive the same value (for example in an area where the correlate values happen to be uniform), but other projections in other coarser-grained geographic areas will yield uneven projections. Finally in this embodiment, the respective projected values for each of the corresponding finer-grained geographic areas are stored in memory of the geographic information system in association with the respective finer-grained geographic areas, as indicated by block 46.

Thus, some embodiments provide a process or system for using geographic data describing larger areas, such as zip codes, states, and counties, to characterize relatively small, finely-grained geographic areas, such as square tiles a few hundred meters on a side. The resulting data can be used by advertisers to target advertisements more precisely than would be possible with the coarser-grained geographic area, for example, targeting mailings to a particular part of a zip code that likely accounts for some attribute of the zip code that is desirable to the advertiser. Further, some embodiments perform these projections on relatively large data sets, describing relatively large geographic areas, in a fashion that accounts for relatively detailed models of how the aggregate values are to be projected, and such calculations are performed relatively quickly in a fashion that would be prohibitively expensive, if not impossible, to do purely manually in a useful way.

FIG. 3 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). In some embodiments, the program may be conveyed by a propagated signal, such as a carrier wave or digital signal conveying a stream of packets.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes,” and the like, mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,” “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining,” or the like, refer to actions or processes of a specific apparatus, such as a special purpose computer or a similar special purpose electronic processing/computing device. In the context of this specification, a special purpose computer or a similar special purpose electronic processing or computing device is capable of manipulating or transforming signals, for instance signals represented as physical electronic, optical, or magnetic quantities within memories, registers, or other information storage devices, transmission devices, or display devices of the special purpose computer or similar special purpose processing or computing device.

What is claimed is:

1. A method of augmenting a geographic information system by projecting lower-geographic-resolution data on to higher-geographic-resolution areas, the method comprising:
obtaining aggregate values each describing an attribute of different coarser geographic areas;
obtaining a geographic-information system (GIS) having records each describing attributes of a finer-grained geographic area, wherein a plurality of the finer-grained geographic areas are in each of the coarser geographic areas;
identifying, for each of the coarser geographic areas, corresponding finer-grained geographic areas of the GIS that are in the respective coarser geographic area;
projecting, for each of the coarser geographic areas, the aggregate value of the respective coarser geographic area unevenly onto the corresponding finer-grained geographic areas based on respective attribute values of the corresponding finer-grained geographic areas; and
storing in memory of the GIS, for each of the corresponding finer-grained geographic areas of each of the coarser geographic areas, the respective projected value in association with the respective finer-grained geographic area, wherein the respective projected values have different values in the different corresponding finer-grained geographic areas of a given coarser geographic area.

2. The method of claim 1, wherein:
the aggregate values include data describing a population attribute averaged by zip code;
the finer-grained geographic areas are grid tiles of less than or equal to 10,000 meters squared;
the respective attribute values are an estimated number of people in each grid tile based on cell-phone usage occurring in the grid tiles; and
projecting the aggregate values comprises attributing a larger portion of each aggregate value to grid tiles having a larger number of people than to those grid tiles having fewer people.

3. The method of claim 1, wherein projecting the aggregate value comprises:
obtaining for each of the finer-grained geographic areas in a given coarser geographic area a respective correlate value that correlates to the aggregate value;
normalizing the correlate values; and
calculating, for each of the finer-grained geographic areas in the given coarser geographic area, the respective projected value based on the respective normalized correlate value and the aggregate value of the coarser geographic area.

4. The method of claim 3, wherein normalizing the correlate values comprises:
summing the correlate values of each of the corresponding finer-grained geographic areas in the given coarser geographic area; and
dividing each of the correlate values by the sum.

5. The method of claim 3, wherein correlate values are estimated populations in the respective finer-grained geographic area.

6. The method of claim 5, wherein:
the finer-grained geographic area is a grid having a unit cell of smaller than 50,000 square meters;
the coarser geographic areas are, on average, larger than two unit cells;
the aggregate value of the geographic area is a population statistic describing the coarser geographic area; and
calculating the respective projected values comprises attributing an unequal portion of the population statistic to different corresponding finer-grained geographic areas in each coarser geographic area.

7. The method of claim 5, wherein the populations are sub-populations of the general population, the sub-populations being people having an attribute correlated to the aggregate value of the coarser geographic area.

8. The method of claim 7, wherein aggregate value is projected based both on the size of the sub-population in each corresponding finer-grained geographic area and the amount of correlation.

9. The method of claim 3, wherein:
the correlate value for each finer-grained geographic area is a plurality of correlate values each corresponding to different times of day; and
calculating the respective projected values comprises calculating a different respective projected value for each time of day for each of the finer-grained geographic areas.

10. The method of claim 3, wherein the correlate values are cellular data indicative of cellular usage in each of the finer-grained geographic areas based on signals received by cellular base stations.

11. The method of claim 3, wherein the correlate values are application usage data indicative of geographic locations of users of applications determined by location sensors in user devices or by geocoding internet protocol addresses of the user devices.

12. The method of claim 1, wherein projecting a given aggregate value of a given coarser geographic area unevenly onto the corresponding finer-grained geographic areas based on respective attributes of the finer-grained geographic areas comprises:
projecting the given aggregate value onto the corresponding finer-grained geographic areas differently in each of a plurality of different time bins for each finer-grained geographic area.

13. The method of claim 12, wherein a time-bin for a given corresponding finer-grained geographic area is assigned a different projected value for times during the day than during the evening.

14. The method of claim 1, wherein projecting comprises:
identifying a plurality of attributes of the corresponding finer-grained geographic areas, the plurality of attributes and an interaction variable being correlated with the aggregate value;
estimating the aggregated value for each of the finer-grained geographic areas based on the correlation with the plurality of attributes;
normalizing the estimated values such the estimated values sum to approximately one for the corresponding finer-grained geographic areas in a given coarser-grained geographic area; and
multiplying the aggregated value by the respective normalized estimated value for each corresponding finer-grained geographic area.

15. The method of claim 1, wherein the GIS comprises:
a grid of tiles, each tile corresponding to a different geographic area, and at least some of the tiles being the corresponding finer-grained geographic areas, wherein:
each tile is associated with a plurality of time bins each corresponding to different portions of the day, week, month, or year; and
each time bin for each tile is associated with a plurality of attributes, each attribute having an attribute name and an attribute score.

16. The method of claim 15, comprising:
identifying, for each of the coarser geographic areas, corresponding tiles in the respective coarser geographic area; and
calculating, for an attribute of a time bin of each of the corresponding tiles, an attribute score based on the aggregate value of the respective coarser geographic area.

17. The method of claim 1, comprising:
receiving, from a user, a request for an attribute of a query area;
determining that the query area includes one of the corresponding finer-grained geographic areas;
sending to the user an attribute score based on one of the aggregate values.

18. The method of claim 1, comprising selecting an advertisement based on one of the projected values.

19. A tangible, non-transitory, machine-readable medium storing instructions that when executed by a data processing apparatus cause the data processing apparatus to perform operations comprising:
obtaining aggregate values each describing an attribute of different coarser geographic areas;
obtaining a geographic-information system (GIS) having records each describing attributes of a finer-grained geographic area, wherein a plurality of the finer-grained geographic areas are in each of the coarser geographic areas;
identifying, for each of the coarser geographic areas, corresponding finer-grained geographic areas of the GIS that are in the respective coarser geographic area;
projecting, for each of the coarser geographic areas, the aggregate value of the respective coarser geographic area unevenly onto the corresponding finer-grained geographic areas based on respective attribute values of the corresponding finer-grained geographic areas; and
storing in memory of the GIS, for each of the corresponding finer-grained geographic areas of each of the coarser geographic areas, the respective projected value in association with the respective finer-grained geographic area, wherein the respective projected values have different values in the different corresponding finer-grained geographic areas of a given coarser geographic area.

20. A system, comprising:
one or more processors; and
memory storing instructions that when executed by the processors cause the processors to effectuate operations comprising:
obtaining aggregate values each describing an attribute of different coarser geographic areas;
obtaining a geographic-information system (GIS) having records each describing attributes of a finer-grained geographic area, wherein a plurality of the finer-grained geographic areas are in each of the coarser geographic areas;
identifying, for each of the coarser geographic areas, corresponding finer-grained geographic areas of the GIS that are in the respective coarser geographic area;
projecting, for each of the coarser geographic areas, the aggregate value of the respective coarser geographic area unevenly onto the corresponding finer-grained geographic areas based on respective attribute values of the corresponding finer-grained geographic areas; and
storing in memory of the GIS, for each of the corresponding finer-grained geographic areas of each of the coarser geographic areas, the respective projected value in association with the respective finer-grained geographic area, wherein the respective projected values have different values in the different corresponding finer-grained geographic areas of a given coarser geographic area.
